(19) United States
(12) Patent Application Publication
(10) Pub. No.: US 2010/0067867 A1
(43) Pub. Date: Mar. 18, 2010

(54) SYSTEM AND METHOD FOR SEARCHING VIDEO SCENES

(75) Inventor: Chen-Hui Lin, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/499,026

(22) Filed: Jul. 7, 2009

(30) Foreign Application Priority Data
Sep. 12, 2008 (CN) 200810304482.4

(51) Int. Cl. H04N 5/91

(52) U.S. Cl. 386/69

(57) ABSTRACT

A system and method for searching video scenes stored in an electronic device includes acquiring video captions of the video and dividing the video captions into a plurality of caption segments, creating a plurality of caption files to contain the plurality of caption segments, and dividing the video into a plurality of video clips according to the plurality of caption segments. The system and method further includes searching the plurality of caption files for caption segments comprising keywords, and determining the video clips corresponding to searched caption files.

### BACKGROUND

1. Technical Field

Embodiments of the present disclosure relate to search systems and methods, and more particularly to a system and method for searching video scenes.

2. Description of Related Art

Electronic devices may be used to play videos and music, for example. Many videos are very long and may take more than 90 minutes to view from the beginning to the end of the video. If people want to find a specific scene in the video, they have to drag a progress bar of a video player program to search for the specified scene, which is too time consuming.

What is needed, therefore, is an improved system and method for searching video scenes.

### BRIEF DESCRIPTION OF THE DRAWINGS

FIG. 1 is a block diagram of one embodiment of a searching system.

FIG. 2 is a schematic diagram of one embodiment of caption files and video clips.

FIG. 3 is a flowchart of one embodiment of a method for searching video scenes stored in the electronic device of FIG. 1.

### DETAILED DESCRIPTION

All of the processes described may be embodied in, and fully automated via, functional code modules executed by one or more general purpose computers or processors. The code modules may be stored in any type of computer-readable medium or other storage device. Some or all of the methods may alternatively be embodied in specialized computer hardware or electronic apparatus.

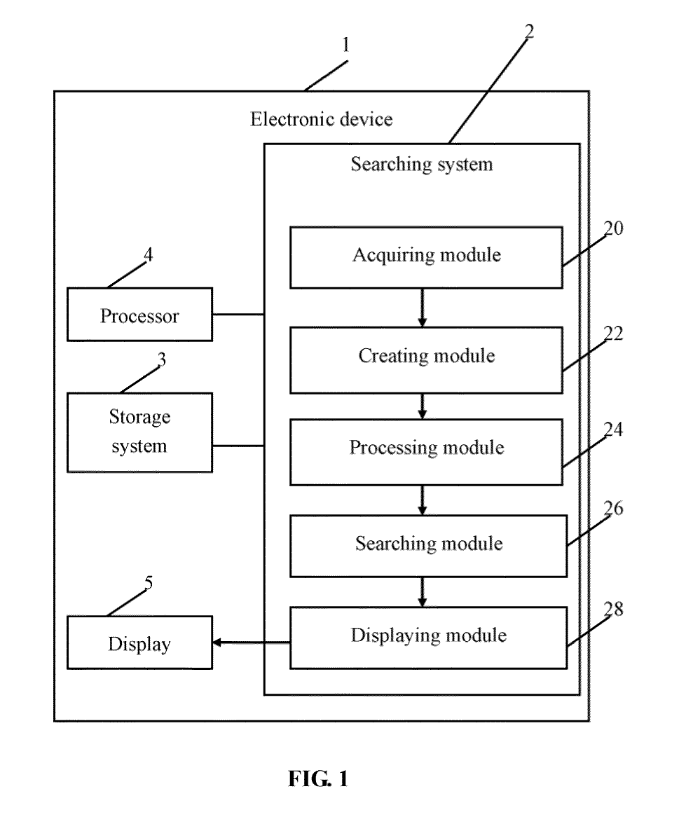

FIG. 1 is a block diagram of one embodiment of a searching system 2. The searching system 2 may be used to search specified scenes in a video stored in the electronic device 1 according to search keywords. The searching system 2 is included in and implemented by an electronic device 1, which is connected with, or installed with a display 5. The searched scenes may be outputted by the display 5.

The electronic device 1 may be a computer, a mobile phone, a personal digital assistant (PDA) device, and any other computing device, for example. In one embodiment, the electronic device 1 may include a storage system 3 and a processor 4. The storage system 3 stores one or more programs, such as an operating system and a media player, other applications of the electronic device 1, and various kinds of data, such as videos, images, messages, for example. In one embodiment, the electronic device 1 may be a mobile phone, and the storage system 3 may be a memory of the electronic device 1 or an external storage card, such as a memory stick, a subscriber identification module (SIM) card, a smart media card, a compact flash card, or any other type of memory card. The processor 4 executes one or more computerized operations of the electronic device 1 and other applications, to provide functions of the electronic device 1.

In one embodiment, the electronic device 1 includes an acquiring module 20, a creating module 22, a processing module 24, a searching module 26, and a displaying module 28. The modules 20, 22, 24, 26, and 28 may be executed by the processor 4 to perform one or more computable operations of the electronic device 1.

The acquiring module 20 acquires video captions of a video stored in the storage system 3, and divides the video captions into a plurality of caption segments. Each caption segment may include one or more sentences or a paragraph, for example. In one embodiment, the acquiring module 20 acquires the video captions using optical character recognition (OCR) technology. The video may be a movie, for example.

The creating module 22 creates a plurality of caption files to contain the plurality of caption segments, and assigns serial numbers to the plurality of caption files. In one embodiment, each caption file contains the same number of captions. To ensure a proper order of video scenes, there is an overlapping of captions from one caption file to the next. In one embodiment, the last few captions of one caption file are also the first few captions of the next caption file so that it is clear what the order of the caption files should be. For example, the creating module 22 may set that each caption file to contain 20 sentences of captions. For example, if there are two adjacent caption files in order from A to B, the last 5 sentences of captions in caption file A are the first 5 sentences of captions in caption file B.

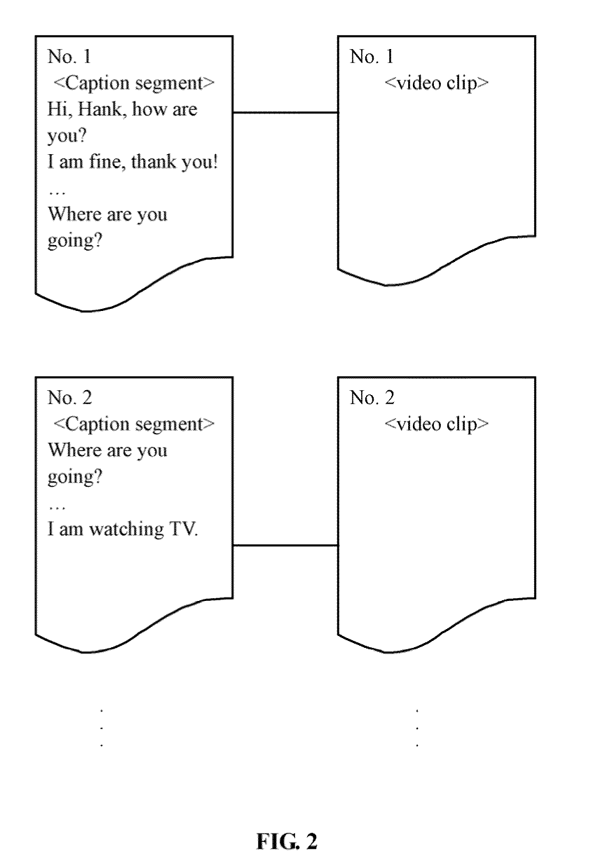

The processing module 24 divides the video into a plurality of video clips according to the plurality of caption segments, and numbers the plurality of video clips according to the serial numbers of the plurality of caption files. As shown in FIG. 2, each caption file corresponds to a video clip. In one embodiment, each of the video clips may include one or more scenes.

The creating module 22 also creates a database in the storage system 3, and store the plurality of caption files and the plurality of video clips into the database.

The searching module 26 receives keywords input through the electronic device 1. The user may input any keywords, and the searching module 26 may process the keywords by filtering out predetermined unnecessary words, such as “a,” “an,” “the,” for example.

The searching module 26 also searches through the plurality of caption files for caption segments including the keywords, and acquires searched caption files including the keywords. If there are no caption files that include the keywords, the searching module 20 notifies a user of the electronic device 1 that no caption file includes the keywords.

The searching module 26 further determines serial numbers of the searched caption files, and determines the video clip corresponding to the searched caption files according to the determined serial numbers. The displaying module 28 displays a search list of the determined video clips on the display 5 of the electronic device 1.

The displaying module 28 may further calculate a weight of the keywords in each of the searched caption files, order the searched caption files according to the calculated weight of the keywords in each of the searched caption files, and order the determined video clips in the search list according to the ordered caption files. In one embodiment, the weight of the keywords in each of the searched caption files is calculated according to frequencies of occurrence of the keywords in each of the searched caption files. In another embodiment, the weight of the keywords may be calculated according to how many of the keywords are found in one video segment. For example, the user enters four keywords, and there is a caption file that includes three of the four keywords has been found. That is, the weight of the found caption file is 75%.

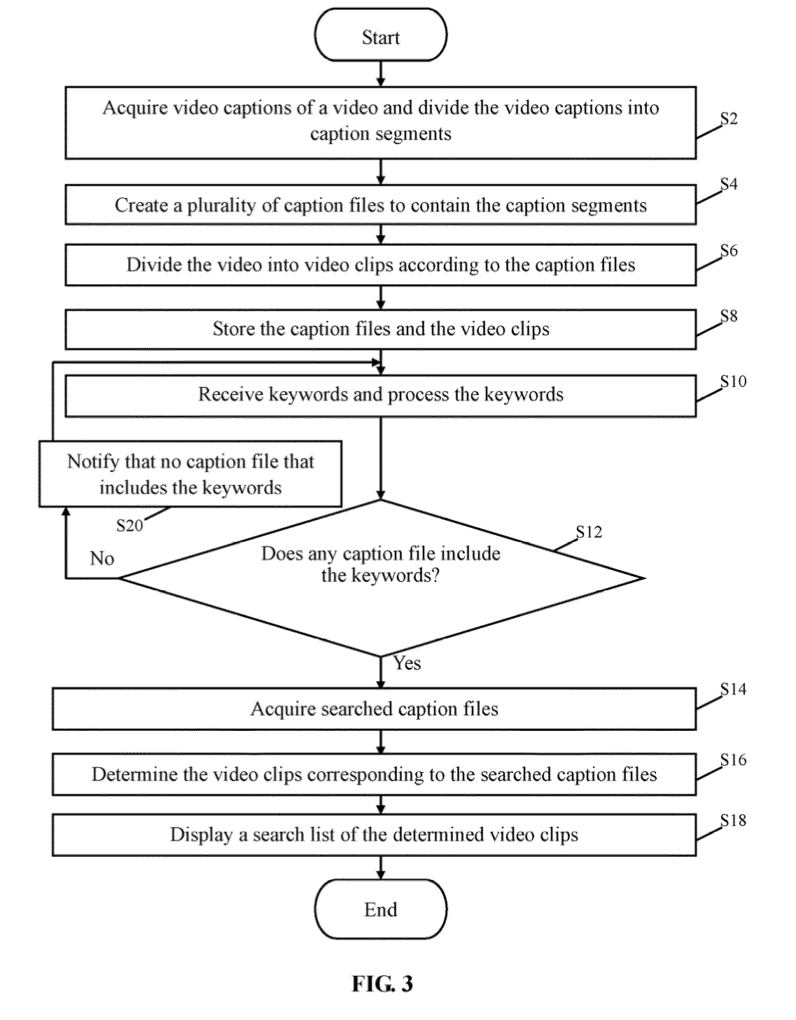

FIG. 3 is a flowchart of one embodiment of a method for searching video scenes stored in the electronic device 1 of FIG. 1. Depending on the embodiment, additional blocks may be added, others removed, and the ordering of the blocks may be replaced.

In block S2, the acquiring module 20 acquires video captions of a video stored in the storage system 3, and divides the video captions into a plurality of caption segments. As mentioned above, the acquiring module 20 acquires the video captions using optical character recognition (OCR) technology.

In block S4, the creating module 22 creates a plurality of caption files to contain the plurality of caption segments, and assigns serial numbers to the plurality of caption files.

In block S6, the processing module 24 divides the video into a plurality of video clips according to the plurality of caption segments, and numbers the plurality of video clips according to the serial numbers of the plurality of caption files.

In block S8, the creating module 22 creates a database in the storage system 3, and store the plurality of caption files and the plurality of video clips into the database.

In block S10, the searching module 26 receives keywords input through the electronic device 1, and processes the keywords by filtering out predetermined unnecessary words, such as “a,” “an,” “the,” for example.

In block S12, the searching module 26 searches the plurality of caption files, and determines if any caption segment includes the keywords. If there are one or more caption files that include the keywords, in block S14, the searching module 26 acquires searched caption files including the keywords, and determines serial numbers of the searched caption files.

In block S16, the searching module 26 determines the video clips corresponding to the searched caption files according to the determined serial numbers.

In block S18, the displaying module 28 displays a search list of the determined video clips on the display 5 of the electronic device 1.

If there are no caption files that include the keywords, in block S20, the searching module 20 notifies a user of the electronic device 1 that no caption file includes the keywords, and then the procedure returns to block S10.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A video scene searching method, the method comprising:
acquiring video captions of a video stored in a storage system of an electronic device, and dividing the video captions into a plurality of caption segments;
creating a plurality of caption files to contain the plurality of caption segments, and assigning serial numbers to the plurality of caption files;
dividing the video into a plurality of video clips according to the plurality of caption segments, and numbering the plurality of video clips according to the serial numbers of the plurality of caption files;
receiving keywords input through the electronic device;
searching the plurality of caption files for caption segments comprising the keywords;
acquiring searched caption files that comprise the keywords;
determining serial numbers of the searched caption files;
determining the video clips corresponding to the searched caption files according to the determined serial numbers; and
displaying a search list of the determined video clips on a display of the electronic device.

2. The method according to claim 1, further comprising:
processing the keywords by filtering out predetermined unnecessary words in the keywords before the searching step.

3. The method according to claim 1, further comprising:
calculating a weight of the keywords in each of the searched caption files;
ordering the searched caption files according to the calculated weight of the keywords in each of the searched caption files; and
ordering the determined video clips in the search list according to the ordered caption files.

4. The method according to claim 1, wherein the weight of the keywords in each of the searched caption files is calculated according to frequencies of occurrence of the keywords in each of the searched caption files.

5. The method according to claim 1, further comprising:
creating a database in the storage system of the electronic device; and
storing the plurality of caption files and the plurality of video clips into the database.

6. The method according to claim 1, wherein the video captions are acquired using optical character recognition technology.

7. A computing system for searching video scenes stored in an electronic device, the computing system comprising:
a storage system;
at least one processor; and
one or more programs stored in the storage system and being executable by the at least one processor, the one or more programs comprising:
an acquiring module operable to acquire video captions of a video stored in the storage system, and divide the video captions into a plurality of caption segments;
a creating module operable to create a plurality of caption files to contain the plurality of caption segments, and assign serial numbers to the plurality of caption files;
a processing module operable to divide the video into a plurality of video clips according to the plurality of caption segments, and number the plurality of video clips according to the serial numbers of the plurality of caption files;
a searching module operable to search the plurality of caption files for caption segments comprising keywords input through the electronic device, acquire searched caption files that comprise the keywords, determine serial numbers of the searched caption files, and determine the video clips corresponding to the searched caption files according to the determined serial numbers; and
a displaying module operable to display a search list of the determined video clips on a display of the electronic device.

8. The computing system according to claim 7, wherein the searching module is further operable to process the keywords by filtering out predetermined unnecessary words in the keywords.

9. The computing system according to claim 7, wherein the displaying module is further operable to calculate a weight of the keywords in each of the searched caption files, order the searched caption files according to the calculated weight of the keywords in each of the searched caption files, and order the determined video clips in the search list according to the ordered caption files.

10. The computing system according to claim 9, wherein the weight of the keywords in each of the searched caption files is calculated according to frequencies of occurrence of the keywords in each of the searched caption files.

11. The computing system according to claim 7, wherein the creating module is further operable to create a database in the storage system, and store the plurality of caption files and the plurality of video clips into the database.

12. The computing system according to claim 7, wherein the video captions are acquired using optical character recognition technology.

13. A storage medium storing a set of instructions, the set of instructions capable of being executed by a processor to perform a method for searching video scenes stored in an electronic device, the method comprising:
acquiring video captions of a video stored in a storage system of the electronic device, and dividing the video captions into a plurality of caption segments;
creating a plurality of caption files to contain the plurality of caption segments, and assigning serial numbers to the plurality of caption files;
dividing the video into a plurality of video clips according to the plurality of caption segments, and numbering the plurality of video clips according to the serial numbers of the plurality of caption files;
receiving keywords input through the electronic device;
searching the plurality of caption files for caption segments comprising the keywords;
acquiring searched caption files that comprise the keywords;
determining serial numbers of the searched caption files;
determining the video clips corresponding to the searched caption files according to the determined serial numbers; and
displaying a search list of the determined video clips on a display of the electronic device.

14. The storage medium as claimed in claim 13, wherein the method further comprises:
processing the keywords by filtering out predetermined unnecessary words in the keywords before the searching step.

15. The storage medium as claimed in claim 13, wherein the method further comprises:
calculating a weight of the keywords in each of the searched caption files;
ordering the searched caption files according to the calculated weight of the keywords in each of the searched caption files; and
ordering the determined video clips in the search list according to the ordered caption files.

16. The storage medium as claimed in claim 15, wherein the weight of the keywords in each of the searched caption files is calculated according to frequencies of occurrence of the keywords in each of the searched caption files.

17. The storage medium as claimed in claim 13, wherein the method further comprises:
creating a database in the storage system of the electronic device; and
storing the plurality of caption files and the plurality of video clips into the database.

18. The storage medium as claimed in claim 13, wherein the video captions are acquired using optical character recognition technology.
